(19) United States
(12) Patent Application Publication
(10) Pub. No.: US 2014/0290185 A1
(43) Pub. Date: Oct. 2, 2014

(54) Multi-layer barrier film and use thereof

(71) Applicant: 2 GAMMA S.R.L., Mondovi (IT)

(72) Inventor: Marco Forzano, Mondovi (CN) (IT)

(73) Assignee: 2 GAMMA S.R.L., Mondovi (CN) (IT)

(21) Appl. No.: 14/349,032

(22) PCT Filed: Oct. 24, 2012
(86) PCT No.: PCT/IB2012/055856

§ 371 Date: Apr. 1, 2014

(30) Foreign Application Priority Data
Oct. 25, 2011 (IT) GE2011A000121

(51) Int. Cl. B32B 27/08; B65B 25/04; B32B 27/32; B32B 27/30; B32B 27/34

(52) U.S. Cl. CPC B32B 27/08; B32B 27/306; B32B 27/304; B32B 27/34; B32B 27/32; B32B 27/327; B65B 25/041
USPC 53/461; 428/220

(57) ABSTRACT

A multi-layer barrier film made of a plastic material adapted for covering and/or wrapping natural products used both for animal feeding and as raw materials for plants producing energy from renewable sources, particularly ensiled agricultural vegetable products such as chopped fodder or the like, includes at least one barrier layer made of an air-impermeable, and particularly oxygen-impermeable, plastic material for preventing aerobic fermentation of the ensiled product or for limiting it to the lactic fermentation caused by anaerobic microorganisms. The film has an oxygen permeability value, measured at 0% humidity and at 20° C., not higher than 300 cc/m²/day/atm in the stretched or not stretched condition, with an overall thickness not higher than 500 μm.

The present invention relates to a multi-layer barrier film made of plastic material and to the use of such multi-layer barrier film.

It is known to use films for storing and preserving agricultural products, particularly chopped fodder or other vegetable products for zootechnical use which products are an important component for livestock feed able to completely replace green, fodder (grass) and partially the dry one (hay).

Polyethylene films and films composed of several layers made of different materials (polyethylene and polyamide) assembled together to provide a protective action are known. The patent application WO2010/039687 describes a mono or multi-layer film having barrier properties.

The mono-layer film is a mixture of 2 components:

1) linear low-density polyethylene

2) propylene-based polymer, high-density polyethylene and combinations thereof.

The propylene-based polymer can be:

propylene homopolymer,

propylene/alpha-olefin interpolymer

propylene/ethylene interpolymer

propylene/ethylene copolymer.

The multi-layer film has an inner layer located between two outer layers.

The inner layer is composed of one or more of the following compounds:

high-density polyethylene and/or any of the foregoing propylene-based polymers.

The outer layers may be the same or different and are composed of one or more of the following compounds:

linear low-density polyethylene,

high-density polyethylene, and any of the foregoing propylene-based polymers.

Therefore the patent does not provide to make a film with a polyamide-based or EVOH-based barrier layer.

The patent GB 2359273 describes a general film for ensiling bales.

The film comprises at least two distinct elements 12 (a), (b) and 14.

The element 14 has a lower permeability to fluids than the first of the two elements 12 (a), (b).

The external elements (12) may be LLDPE, LDPE, EVA, or copolymers or terpolymers of ethylene and acrylic acids, esters of acrylic acids, vinyl acetate or styrene.

The internal element 14 may be nylon, PET, EVOH, or ethylene-CO copolymer.

The film object of patent GB 2359273 aims at overcoming the low barrier effect in relation to fluids, particularly oxygen, of known films made of LLPDE (linear low-density polyethylene) and at avoiding the practice of wrapping silage bales with eight layers of such film in order to try to decrease the oxygen transmission.

Therefore the patent solves the above drawback, by a film having typical dimensions of 750 millimetres in width, and around 25 microns thick, with a barrier layer 14 of approximately 2 microns thick. In this way the deformability of the outer layers is not restricted by the barrier layer.

The film described in patent GB 2359273 does not solve the problem of providing a covering wrap or sheeting, which in addition to limit or prevent oxygen transmission, can also be resistant to physical and mechanical forces and therefore resistant also to ageing, while maintaining such elasticity and weight characteristics that make it easy to be used on the field.

The patent application WO2011/057752 describes a film suitable for covering trenches composed of at least two films detacheable from each other such to facilitate the recycling of the materials.

Said film has not elasticity and mechanical properties that make it applicable also for wrapping round bales.

The patent JP 2003276123 describes a multi-layer film with a barrier layer composed of aliphatic polyamide, that is more elastic than polyamide.

The patent DE 102004008085 describes a multi-layer film, for covering biomass, with a barrier layer composed of EVOH and/or aluminium. Preferably the barrier layer is interposed between two polyethylene layers having a preserving action against mechanical stresses.

The film with a thickness of about 170 micron and with oxygen permeability not greater than 1 cm³/(m² d bar) is described as being mechanically stable but flexible and easy to be transported. The patent does not provide further details about the mechanical properties of the film.

It is known that layers forming an oxygen barrier can be composed of polyamide (PA) or EVOH (ethylene-vinyl alcohol copolymer).

The polyamide, less expensive than EVOH, has a barrier effect lower than EVOH, which has a high barrier effect and is more recyclable. Therefore in order to have a good barrier effect by using polyamide it is necessary to have a considerably thick layer, with respect to an EVOH layer.

The patent application WO 2009/060480 describes a plastic film for greenhouses with one or more layers containing polyamide. The patent provides the use of polyamide for obtaining a high heat insulation effect and barrier effect (for protecting the polyethylene layer or layers) against pesticides and/or chemical agents used in the greenhouse. As pointed out in the first claim the layer or layers comprise polyamide with low permeability to gases or gas mixtures of chemical agents and/or pesticides.

The patent does not provide information about the oxygen barrier value of the film containing polyamide and about mechanical properties of this film.

The patent EP2286658 describes in details the composition of a resin that can be used for forming a barrier layer to be used for making a multi-layer film for silages, based on saponified EVA (ethylene-vinyl acetate). Table 1 shows the values of oxygen permeability, elongation and breaking of a multi-layer film (seven layers) with barrier layer composed of a specific resin object of the invention.

As described in the text (paragraph 0127) thanks to the specific composition of the barrier layer it is possible to obtain a film with oxygen barrier properties and mechanical properties better than known polyamide and polyethylene-based films.

Table 2 compares the mechanical values of a multi-layer film (5 layers) with a barrier layer composed of the specific resin object of the invention wherein, in the composition composing the barrier layer, the ratio by weight of EVOH to saponified EVA is changed: the table shows how a layer composed of pure EVOH (comparative example 4) has very low stretchability characteritics but by blending with another material (saponified EVA) a higher stretchability is obtained spoiling, on the other hand, a part of the barrier effect.

Therefore the patent relates to the composition of a barrier layer made of EVOH/saponified EVA and it shows how the blending of EVOH with saponified EVA allows a more elastic layer to be obtained affecting the barrier effect.

A multi-layer sheeting is described in the patent EP 1035762.

Silage results from a fodder preserving technique (ensiling) performed by acidification of the vegetable mass caused by anaerobic microorganisms in order to prevent potentially toxic and deteriorating microorganisms from proliferating into the vegetable mass leading to its consumption (loss of nutritional value) and to wholesomeness alteration.

It is known to store and preserve fodder in specific closed spaces (silos) or even outside.

Silos, by isolating the vegetable mass from the external environment, prevent oxygen from being fed and that naturally present in the mass is consumed during the aerobic acetic fermentation, in the first days, by the aerobic bacteria present. The acidification of the environment of silos (ph 4.5-5) leads to the development of lactic batteria that will perform the lactic fermentation, bringing pH to values even lower than 4, responsible for the optimal silage preservation.

It is known that chopped fodder or other vegetable products for the zootechnical use can be ensiled at the green condition outside, into concrete pits, in stacks on the ground or in cylindrical or prismatic bales.

The fundamental condition for obtaining an optimal silage is the storage and preservation under anaerobiosis conditions, depending on the arrangement of the working and harvesting environment and on the modes and products used for the storage.

The ensiling methods change depending on several factors such as the type of crop, the size of the livestock, the size of the firm, the type of livestock.

The trench ensiling provides the trench to be filled with fodder in inclined layers, leaned and compacted against the bottom wall.

In order to obtain a airtight sealing usually a polyethylene sheet is leaned on the walls of the silo that after the filling is turned towards the top and it is covered by another polyethylene sheet. After closing the silo the vegetable mass is maintained compressed by arranging a weighting material on the polyethylene cover guaranteeing a uniform load.

As an alternative the fodder can be arranged in compacted stacks covered by polyethylene sheets (stack ensiling) on a concrete bed or directly on the ground. A weighting material layer is put on the covering sheeting.

The ensiling of fodder bales provides cylindrical or prismatic bales to be stacked and then covered by a sheeting (generally made of polyethylene) (round bale ensiling in storage silo) or they are individually wrapped, closed and then stacked (round bale ensiling by wrapping).

It is possible to provide the bales to be stored into tubes made of plastic material (round bale ensiling by bagging).

The fodder can also be ensiled as loose by bagging it into tubes composed of a film of plastic material.

In order to have quality silage it is necessary during the loading to compress as much as possible the fodder such to exclude air from the vegetable mass.

The covering sheeting or wrap used during the ensiling process has to be cheap, resistant to puncture and tearing, resistant to ageing, and with a limited thickness such to limit the manufacturing, transport and use costs, to guarantee it to perfectly fit the shape of the vegetable mass and therefore to perfectly contain the ensiled product, for facilitating the covering, wrapping, filling operations.

Moreover it has to be considered that the sheeting or wrap in addition to allow the ensiled product to be protected it has to prevent air from entering it such to avoid the harmful surface fermentation and such to obtain only the so called low fermentation caused by a lactic fermentation flora of anaerobic micro-organisms.

The sheeting or wrap have to maintain the anaerobiosis condition: for the silage quality to be maintained it is necessary for the sheeting or wrap to be impermeable to oxygen in order to avoid moulds and yeasts, pathogenic organisms from proliferating, with dry matter losses and heating of the mass.

The object of the present invention is a multi-layer barrier film made of plastic material to be used for covering and/or wrapping natural products, which products are used both for animal feeding and as raw material for plants producing energy from renewable sources, particularly ensiled agricultural vegetable products such as chopped fodder or the like, which film comprises at least one barrier layer made of air-impermeable and particularly oxygen-impermeable plastic material for preventing the aerobic fermentation of the ensiled product or for limiting it to the lactic fermentation caused by anaerobic microorganisms, which film has an oxygen permeability value not higher than 300 cc/m²/day/atm for a film in the stretched or not-stretched condition, with a total thickness not higher than 500 μm.

It has to be considered that generally the barrier properties increase as the thickness increases that is permeability to gases, in particular to oxygen, decreases as the thickness increases.

According to the present invention the oxygen permeability values are measured at 0% humidity and 20° C.

The film object of the present invention therefore has optimal properties as barrier film in relation to fluids, in particular oxygen, and at the same time it is very elastic and it has high mechanical properties, as described below, such that said film is particularly suitable for obtaining the protection of ensiled products, particularly also round bales, whose wrapping requires the film to have specific mechanical properties.

According to the present invention the film is composed of at least two layers.

At least one of said layers is a layer acting as a barrier to gas penetration, particularly oxygen, so called barrier layer.

The film object of the present invention has an overall thickness not higher than 500 μm.

According to the present invention a film, with a overall thickness ranging from 10 to 400 μm, preferably from 15-300 μm, in the not stretched condition, has an oxygen permeability value not higher than 300 cc/m²/day/atm measured at 0% humidity and 20° C.

As the plastic material for the barrier layer or layers of the film according to the invention it is possible to use all the types of polymers, copolymers or mixtures thereof, which allow at least one barrier layer, impermeable to gases, particularly to oxygen to be obtained which at least one barrier layer allows to have a film with a oxygen permeability value not higher than 300 cc/m²/day/atm.

Said at least one barrier layer, impermeable to gases, particularly to oxygen, can be composed of only one polymer or copolymer (monopolymer layer) or a mixture of polymers and/or copolymers, which polymers and/or copolymers are gas-impermeable.

Particularly said at least one barrier layer is made of a mixture consisting of or comprising at least one type of polyamide, ethylene vinyl alcohol (EVOH), polyvinyl alcohol (PVOH), polyvinyldene chloride (PVAL) or the like said polymers and/or copolymers being provided individually or in a mixture with one another.

According to one embodiment the barrier layer is composed of at least one type of polyamide, such as for example nylon or the like.

For making the barrier layer it is possible to use different types of nylon such as nylon 6 and/or 6,66 or the like.

It is possible to use other polymers/copolymers for forming the barrier layer such as for example ethylene vinyl alcohol (EVOH), polyvinyl alcohol (PVOH), polyvinyldene chloride (PVAL) or the like.

Said polymers/copolymers listed above such as ethylene vinyl alcohol (EVOH), polyvinyl alcohol (PVOH), polyvinyldene chloride (PVAL) or the like, can be provided individually, that is pure, not mixed one with the other, to form the barrier layer (for example it is possible to have a barrier layer made of EVOH) or they can be provided mixed one with the other, even if they do not belong to the same family, to form the barrier layer.

It is possible to provide a multi-layer film wherein said at least one barrier layer is composed of EVOH or a film wherein at least a barrier layer is composed of polyamide or a film wherein there are provided at least two barrier layers, one made of EVOH and one of polyamide, or a film wherein at least one barrier layer is composed of polyamide mixed with EVOH for instance.

Obviously it is possible to provide only one type of polyamide or two or more types of polyamides different one another and mixeable together to make the barrier film.

In the embodiment wherein the film comprises two or more barrier layers it is possible for said layers to have all the same composition.

Obviously it is possible to provide the two or more barrier layers provided in the film to have a different composition: for example it is possible for the barrier layers of a film to have a composition different from one another or that in the film there are provided some barrier layers having a composition identical one another but different than that of other barrier layers provided in the same film.

For example it is possible to provide a film with at least one barrier layer composed of polyamide and at least one barrier layers composed of EVOH.

The film according to the present invention can be composed only of barrier layers.

The film object of the present invention therefore has optimal properties as barrier film and at the same time it has optimal mechanical properties.

This sinergy is particularly useful when using the film for wrapping round bales.

The barrier film object of the present invention comprises at least one polyolefin layer composed of a mixture comprising or consisting of polyethylene (PB) such a linear low-density polyethylene (LLDPE) and/or low-density polyethylene (LDPE) and/or polypropylene (PP) and/or EVA or the like, said compounds being provided individually (namely pure) or in a mixture with one another, which film has the following mechanical properties, said values being intended as minimum values and one or more of said values being provided in combination or alternatively one another:

| | Unit of | | | |
|---|---|---|---|---|
| Analysis | measurement | Value | | Standard |
| Tearing | nM | MD | 1792 | ASTM D 1922 |
| (ELMENDORF) | | TD | 3360 | |
| Tensile strength | N/mm² | MD | 18.96 | ASTM D 882 |
| | | TD | 18 | |
| Yield strength | N/mm² | MD | 9.84 | ASTM D 882 |
| | | TD | 8.48 | |
| Elongation at | % | MD | 419.12 | ASTM D 882 |
| break | | TD | 514.4 | |
| Elongation at | % | MD | 6.8 | ASTM D 882 |
| yield | | TD | 4.24 | |
| Energy at break | J | MD | 3.6 | ASTM D 882 |
| | | TD | 3.92 | |
| Modulus of | N/mm² | MD | 196 | ASTM D 882 |

| | | | |
|---|---|---|---|
| Elasticity(YOUNG) | | | |
| Puncture | N/mm | 1116.16 | ASTM D 4649 |
| resistance | | | |
| Puncture | mm | 32.72 | ASTM D 4649 |
| deformation | | | |
| Probe penetration | mm | 11 | ASTM F1306 |
| Falling dart test | g | 95 | ASTM D1709 |

MD: “machine direction” orientation
TD: “transverse direction” orientation

The layers different from the barrier layer, in particular the polyolefin layer or layers are the structural layers of the film.

Moreover they can perform protective actions towards the vegetable mass: they can protect the fodder from the action of UV rays and/or perform a covering action.

The known films in order to have barrier properties and mechanical properties similar to the film object of the present invention have to considerably increase the overall thickness of the film affecting the cheapness and the easiness in using the film.

On the contrary the film object of the present invention combines small thicknesses of the film with optimal mechanical, lightweight, cheapness, storage easiness, transport and use properties.

The film object of the present invention can be stretched (or stretchable) or non-streteched, so called stretch or non-stretch film.

The film may be stretched in use or may be pre-stretched.

According to a preferred embodiment of the present invention a “stretch film”, namely a stretchable film, is considered as thin film, that is a film with a thickness, in the not stretched condition, not higher than 50 μm.

The thin film can be stretched till obtaining a reduction by 50% of the original thickness.

Preferably a thin film with at least one barrier layer composed of EVOH is stretched or is considered as stretchable. It is possible to provide the stretched or stretchable film to have one or more barrier layers different from EVOH, such as for example one or more barrier layers composed of nylon.

According to an embodiment the thin stretch film has a thickness ranging from 5 to 50 μm: this means that for example before being stretched, the thickness of the film will not be more than 50 μm, after being stretched the film thickness will not be lower than 5 μm.

For example it is possible to stretch a film of 50 m and to obtain a film with a thickness of 25 μm, or to stretch a film with such a thickness to have, in the stretched condition, a final thickness of 5 μm.

According to the present invention the film can be defined as thin, medium or heavy on the basis of its overall thickness.

Thin film means a film with an overall thickness not higher than 50 μm.

Medium film means a film with an overall thickness not higher than 250 μm.

Heavy film means a film with an overall thickness not higher than 500 μm.

Preferably a thin or medium film has oxygen permeability not higher than 300 cc/m²/day/atm.

The thin multi-layer film is used for wrapping individual round bales of vegetable material such as fodder.

The multi-layer film with medium thickness, with a thickness not lower than 25 μm and not higher than 250 μm, is used for covering vegetable material, such as ensiled fodder.

Preferably a heavy film has a oxygen permeability not higher than 150 cc/m²/day/atm.

The heavy multi-layer film with a thickness not lower than 130 μm and not higher than 500 μm is used for making tubes for containing vegetable material, particularly for ensiling vegetable material such as fodder by bagging that is for the storage and preservation, of vegetables, such as round bales or loose vegetable material, inside tubes composed of the film object of the present invention.

The thin multi-layer film with one or more barrier layers of EVOH has oxygen permeability not higher than 50 cc/m²/day/atm, in the not stretched condition.

The thin multi-layer film with one or more barrier layers of EVOH has oxygen permeability not higher than 100 cc/m²/day/atm, in the stretched condition.

The thin multi-layer film with one or more barrier layers of polyamide, such as for example nylon, has oxygen permeability not higher than 150 cc/m²/day/atm, in the not stretched condition.

The thin multi-layer film with one or more barrier layers of polyamide, such as for example nylon, has oxygen permeability not higher than 300 cc/m²/day/atm, in the stretched condition.

The multi-layer film with medium thickness with one or more barrier layers of EVOH has an oxygen permeability not higher than 60 cc/m²/day/atm.

The multi-layer film with medium thickness with one or more barrier layers of polyamide, such as for example nylon, has oxygen permeability not higher than 300 cc/m²/day/atm.

The heavy multi-layer film with one or more barrier layers of EVOH has oxygen permeability not higher than 50 cc/m²/day/atm.

The heavy multi-layer film, with one or more barrier layers made of polyamide, such as for example nylon, has oxygen permeability not higher than 150 cc/m²/day/atm.

Therefore the object of the present invention is a multi-layer film with at least one barrier layer.

The film object of the present invention is preferably composed of several coextruded layers and adherent one to the other.

It is possible to provide a film composed of one or more barrier layers interposed between polyolefin layers.

The barrier layers can compose inner layers (namely interposed between other layers and, not in contact with the environment) or outer ones of the multi-layer film.

In one embodiment the barrier layers are provided inside the multi-layer film namely the outermost layers of the film intended to come in contact with the air and the vegetable mass are composed of the polyolefin layers.

According to one embodiment, it is possible to provide at least one adhesive layer between the layers composing the multi-layer film.

Said adhesive layer can be composed of a mixture comprising or consisting of linear low-density polyethylene (LLDPE) and/or low-density polyethylene (LDPE) and/or ethylene-vinyl acetate (EVA) and/or polypropylene, used pure or in a mixture with one another.

Preferably the adhesive layer is provided for promoting the adhesion between the barrier layer and the polyolefin layer, giving one or more of the mechanical properties listed above to the multi-layer film, and which protects the barrier layer against external agents.

The adhesive layer can be anyway provided between two polyolefin layers and/or between two barrier layers for promoting the interpolymer adhesion in the multi-layer structure.

Preferably the barrier layer or the barrier layers are interposed between two or more layers, having a composition different than barrier layers, that is adhesive layers and/or more external layers of the film intended to contact the air and the vegetable mass.

Therefore the multi-layer film can comprise one or more of the following layers, preferably two or more of the following layers:

one or more layers with a gas barrier function, particularly to oxygen,

one or more layers with adhesive function,

one or more polyolefin layers giving to the film the mechanical and strength properties listed above, and they act for protecting the barrier layer or layers against external agents.

The polyolefin layer or layers are composed of a mixture comprising or consisting of polyethylene (PE) and/or polypropylene (PP) and/or EVA or the like, such as linear low-density polyethylene (LLDPE) and/or low-density polyethylene (LDPE), said compounds being used pure or in a mixture with one another.

In one embodiment the film object of the present invention comprises one or more layers composed of a mixture comprising linear low-density polyethylene (LLDPE) and/or low-density polyethylene (LDPE).

According to one embodiment the mixture of the polyolefin layer preferably comprises at least one of the known types of linear low-density polyethylene (LLDPE) that is LLDPE-metallocene.

Said compound allows a quality stretchable film to be obtained by the combination of elasticity and resistance properties.

Said compounds, particularly LLDPE and/or LDPE, can be provided individually or mixed with one or more of the following compounds:

polypropylene,

Ethylene vinyl acetate (EVA),

polyisobutylene.

EVA (Ethylene vinyl acetate) gives elasticity to the layer, polyisobutylene gives adhesive and/or binding properties to the layer.

The layer composed of or comprising EVA makes the film elastic and adhesive and said compound can be an alternative to polyisobutylene.

Said substances can be used for forming a layer with an adhesive and/or binding function.

Not limitative examples of mixtures composing the polyolefin layer can be the following:

LDPE, LLDPE, EVA, polypropylene (compounds used, for forming the layer, pure or in a mixture with one another),

VLLDPE (very low density linear polyethylene), LLDPE, EVA, polyisobutylene (compounds used, for forming the layer, pure or in a mixture with one another).

To the mixture of said compounds, particularly to the mixture composing the adhesive layer and/or to the mixture composing the polyolefin layer) it is possible to add additives such as colouring agents and/or anti-UV additives.

Preferably such additives are added to the mixture in a percentage by weight ranging from 1 to 40%.

The layer or layers composed of or comprising LDPE and/or LLDPE' serve for making the film elastic, resistant and lasting over time.

The different types of LLDPE can be used such as:

LLDPE-butene;

LLDPE-hexene;

LLDPE-octene;

LLDPE-metallocene,

VLLDPE namely very low-density linear polyethylene.

Obviously it is possible to provide the compounds giving adhesive and/or binding and/or elasticity properties to be mixed not only to compounds composing the polyolefin layer or layers, but also, as an alternative or in combination, to the compounds composing the barrier layer or layers.

These compounds are the base for making the film object of the invention whose final properties will depend on the type of mixture used and on the final arrangement of the layers.

According to a possible embodiment of the present invention the film comprises two or more of the following layers:

Layer A)

a first polyolefin layer comprising LLDPE and/or LDPE;

in one embodiment the layer preferably comprises LLDPE-butene and/or VLLDPE and/or LLDPE-metallocene; the polyolefin layer can also comprise polyisobutylene and/or EVA; to said mixture it is possible to add colouring agents and/or anti UV additives;

Layer B)

a second polyelfin layer comprising LLDPE and/or LDPE, and/or polypropylene;

in one embodiment the layer preferably comprises LLDPE-metallocene; to said mixture it is possible to add polyisobutylene and/or EVA; to said mixture it is possible to add colouring agents and/or anti UV additives;

Layer C)

a first layer with adhesive function, for example a linear polyethylene-based one;

Layer D)

a barrier layer comprising or preferably composed of EVOH; obviously as an alternative or in combination to EVOH it is possible to use any polymer/copolymer among those listed above in the text having a barrier function;

Layer C^{I})

a second layer with adhesive function, for example a linear polyethylene-based one;

Layer B^{I})

a third polyolefin layer comprising LLDPE and/or LDPE and/or polypropylene;

in one embodiment the layer preferably comprises LDPE-metallocene; to said mixture it is possible to add polyisobutylene and/or EVA; to said mixture it is possible to add colouring agents and/or anti UV additives;

Layer A^{I})

a fourth polyolefin layer comprising LLDPE and/or LDPE;

in one embodiment the layer preferably comprising LLDPE-butene and/or VLLDPE and/or LLDPE-metallocene; to said mixture it is possible to add polyisobutylene and/or EVA; to said mixture it is possible to add colouring agents and/or anti-UV additives;

Obviously it is possible to provide the polyolefin layers and the layers with adhesive function between which at least one barrier layer is interposed to have a composition symmetric or asymmetric one another with respect to, the barrier layer namely the layers provided on the two faces of the barrier layer can have the same composition and arrangement or the layers provided on one side of the barrier layer have a composition and arrangement different than the layers provided on the opposite side of the barrier layer.

According to one embodiment:

A)—the polyolefin layer A is composed of a mixture of LLDPE and/or LDPE to which one or more of the following compounds can be added:

from 0 to 50% by weight of polyisobutylene and/or EVA;

from 0 to 20% by weight of colouring agents;

from 0 to 20% by weight of anti-UV additives;

B)—the polyolefin layer B is composed of a mixture of LLDPE and/or LDPE and/or polypropylene to which it is possible to add one or more of the following compounds:

from 0 to 50% by weight of polyisobutylene and/or EVA;

from 0 to 20% by weight of colouring agents;

from 0 to 20% by weight of anti-UV additives;

C)—the layer C with adhesive function is composed of a mixture of linear low-density polyethylene and/or polypropylene and/or low-density polyethylene and/or EVA to which it possible to add:

from 0% to 40% by weight of anti-UV additives;

D)—the barrier layer D is composed of EVOH or of one or more of the polymers/copolymers listed above and used for forming the barrier layer;

C^{I})—the layer C^{I} with adhesive function is composed of a mixture of linear low density polyethylene and/or polypropylene and/or low density polyethylene and/or EVA to which it is possible to add:

from 0% to 40% by weight of anti-UV additives;

B^{I})—the polyolefin layer B^{I} is composed of a mixture of LLDPE and/or LDPE and/or polypropylene to which it is possible to add one or more of the following compounds:

from 0 to 50% by weight of polyisobutylene and/or EVA;

from 0 to 20% by weight of colouring agents;

from 0 to 20% by weight of anti-UV additives;

A^{I})—a polyolefin layer A^{I} is composed of a mixture of LLDPE and/or LDPE to which it is possible to add one or more of the following compounds:

from 0% to 40% by weight of polyisobutylene and/or EVA;

from 0 to 20% by weight of colouring agents;

from 0 to 20% by weight of anti-UV additives.

According to one embodiment:

A)—the polyolefin layer A is composed of:

from 20 to 90% by weight of LLDPE, preferably LLDPE-butene and/or VLLDPE;

from 10 to 80% by weight of LLDPE, preferably LLDPE-metallocene;

To said mixture it is possible to add:

from 5 to 50% by weight of polyisobutylene and/or EVA;

from 0 to 20% by weight of colouring agents;

from 0 to 20% by weight of anti-UV additives;

B)—the polyolefin layer B is composed of:

from 40 to 90% by weight of LLDPE, preferably LLDPE-metallocene; to which one or more of the following compounds is added:.

from 5 to 50% by weight of polyisobutylene and/or EVA;

from 0 to 20% by weight of colouring agents;

from 0 to 20% by weight of anti-UV additives ,

C)—the layer C with adhesive function is composed of:

from 60 to 100% by weight of linear polyethylene;

from 0% to 40% by weight of anti-UV additives;

D)—the barrier layer D is composed of EVOH;

C^{I})—the layer C^{I} with adhesive function is composed of:

from 60 to 100% by weight of linear polyethylene;

from 0% to 40% by weight of anti-UV additives;

B^{I})—the polyolefin layer B^{I} is composed of:

from 40 to 90% by weight of LLDPE, preferably LLDPE-metallocene; to which one or more of the following compounds is added:

from 5 to 50% by weight of polyisobutylene and/or EVA;

from 0 to 20% by weight of colouring agents;

from 0 to 20% by weight of anti-UV additives;

A^{I})—a polyolefin layer A^{I} is composed of:

from 60 to 99% by weight of LLDPE, preferably LLDPE-metallocene; to which one or more of the' following compounds is added:

from 0% to 40% by weight of polyisobutylene and/or EVA;

from 0 to 20% by weight of colouring agents;

from 0 to 20% by weight of anti-UV additives.

The invention has not to be considered as limited to the examples described above but it is possible to change the composition of the layers and the number and type of the layers provided in the film while maintaining the mechanical, strength, life over time and barrier properties described and claimed.

The examples show a barrier layer made of EVOH but it is possible to use one or more barrier layers with a composition different than only EVOH, as shown in the text.

The layers composing the film object of the present invention are preferably coextruded.

It is further possible for several films to be sealed together to form covering sheetings or wrapping tubes having great dimensions.

The film object of the present invention is used for making sheetings or wraps for covering and/or wrapping natural products, particularly vegetable products, which products can be used both for animal feeding and as raw material for plants producing energy from renewable sources (for example for plants producing biogas), particularly ensiled agricultural products such as ensiled chopped fodder or the like.

The film improves the barrier effect to gases, particularly oxygen, than conventional sheetings and it maintains its qualities unchanged over time, guaranteeing the preservation of the ensiled product for a long time.

The film prevents, by the provision of at least one barrier layer, gasesous exchanges between the atmosphere and the vegetable mass preserving the vegetable mass against the detrimental action of microaerobic yeasts and moulds, allowing only the anaerobic fermentation cauded by lactic batteria.

Moreover the multi-layer structure with a reduced thickness guarantees the highest elasticity, the resistance to tearing and a higher life over time combined with lightweight, handiness and low manufacturing, transport, storage, use and disposal costs.

The elasticity of the film object of the present invention is particularly advantageous in use, particularly for wrapping round bales.

The high oxygen barrier in combination with a high mechanical force allows the amount of plastic material used for the covering/wrapping to be reduced (up to 40% with respect to conventional films) while having a low risk of tearing the film.

The film object of the present invention has further advantages: it is resistant to solvents, is a barrier impermeable not only to oxygen but also to other gases such as nitrogen and carbon dioxide, it is a barrier for odours, it has antistatic properties, it may be coloured or transparent, it can be printable, it can be easily extruded. Moreover the embodiment of the film with at least one barrier layer of EVOH wherein the percentage of EVOH by volume to the overall film can range from about 1 to 5%, considering the chemical nature of EVOH, similar to polyethylene (EVOH contains about from 30% to 50% of ethylene), makes the film object of the present invention easy to be recycled and assimilable to polyethylene as regards recyclability, obviously maintaining the high barrier film characteristics as described above.

The invention claimed is:

1. A multi-layer barrier film made of a plastic material adapter for covering and/or wrapping natural products, said products being used both for animal feeding and as raw materials for plants producing energy from renewable sources, particularly ensiled agricultural vegetable products, comprising:
at least one barrier layer made of an air-impermeable plastic material for preventing aerobic fermentation of an ensiled product or for limiting fermentation to lactic fermentation caused by anaerobic microorganism,
wherein said film has an oxygen permeability value, measured at 0% humidity and at 20° C., no higher than 300 cc/m²/day/atm when said film in a stretched or unstretched condition and an overall thickness no higher than 500 μm.

2. The multi-layer barrier film according to claim 1, wherein said film has an overall thickness ranging from 10 to 400 μm in the unstretched in the unstretched condition, and an oxygen permeability value no higher than 300 cc/m²/day/atm measured at 0% humidity and at 20° C.

3. The multi-layer barrier film according to claim 1, wherein said film comprises at least one polyolefin layer composed of a mixture comprising or consisting of one or more compounds selected from the group consisting of linear low-density polyethylene (LLDPE), low-density polyethylene (LDPE), polypropylene (PP), ethylen-vinyl acetate (EVA), said compounds being provided individually or in a mixture with one another, said film having values of one or more of the following mechanical properties that are provided in combination or alternatively to one another:
Tearing strength (ELMENDORF) (nM): MD 1792; TD 3360 (ASTM D 1922),
Tensile Strength (N/mm²): MD 18.96; TD 18 (ASTM D 882),
Yield strength (N/mm²): MD 9.84; TD 8.48 (ASTM D 882),
Elongation at break (%): MD 419.12; TD 514.4 (ASTM D 882);
Elongation at yield (%): MD 6.8; TD 4.24 (ASTM D 882),
Energy at break (J): MD 3.6; TD 3.92 (ASTM D 882),
Elasticity Modulus (YOUNG) (N/mm²): MD 196 (ASTM D 882),
Puncture resistance (N/mm): 1116.16 (ASTM D 4649),
Puncture deformation (mm): 32.72 (ASTM D 4649),
Penetration probe (mm): 11 (ASTM F1306),
Falling dart test (g): 95 (ASTM D1709).

4. The multi-layer barrier film according to claim 1, wherein said at least one barrier layer is composed of a mixture consisting of or comprising at least one type of polyamide, ethylene vinyl alcohol (EVOH), polyvinyl alcohol (PVOH), or polyvinyldene chloride (PVAL) provided individually or in a mixture with one another.

5. The multi-layer barrier film according to claim 1, wherein said film has an overall thickness no higher than 50 μm.

6. The multi-layer barrier film according to claim 1, wherein said film has an overall thickness no higher than 250 μm.

7. The multi-layer barrier film according to claim 1, wherein said film has an overall thickness no higher than 500 μm, and an oxygen permeability no higher than 150 cc/m²/day/atm.

8. The multi-layer barrier film according to claim 1, wherein said film has an overall thickness no higher than 50 μm and is stretchable till achieving a 50% reduction of an original thickness.

9. The multi-layer barrier film according to claim 1, wherein said film has an overall thickness no higher than 50 μm and has one or more barrier layers made of ethylene vinyl alcohol (EVOH) and an oxygen permeability no higher than 50 cc/m²/day/atm, in the unstretched condition or not higher than 100 cc/m²/day/atm, in the stretched condition.

10. The multi-layer barrier film according to claim 1, wherein said film has an overall thickness no higher than 50 μm and has one or more barrier layers made of polyamide compound, and an oxygen permeability no higher than 150 cc/m²/day/atm, in the unstretched condition or not higher than 300 cc/m²/day/atm, in the stretched condition.

11. The multi-layer barrier film according to claim 1, wherein said film is a multi-layer film having a thickness no higher than 250 μm and one or more barrier layers made of ethylene vinyl alcohol (EVOH) and an oxygen permeability no higher than 60 cc/m²/day/atm.

12. The multi-layer barrier film according to claim 1, wherein said film is a multi-layer film having a thickness no higher than 250 μm, and having one or more barrier layers made of a polyamide compound, and oxygen permeability no higher than 300 cc/m²/day/atm.

13. The multi-layer barrier film according to claim 1, wherein said film is a multi-layer film having a thickness no higher than 500 μm and having one or more barrier layers made of ethylene vinyl alcohol (EVOH) and an oxygen permeability no higher than 50 cc/m²/day/atm.

14. The multi-layer barrier film according to claim 1, wherein said film is a multi-layer film having a thickness no higher than 500 μm and having one or more barrier layers made of a polyamide compound and oxygen permeability no higher than 150 cc/m²/day/atm.

15. The multi-layer barrier film according to claim 1, wherein said at least one barrier layer is provided in combination with one or more polyolefin layers comprising or consisting of one or more compounds selected from the group consisting of linear low-density polyethylene (LLDPE), low-density polyethylene, (LDPE), polypropylene (PP), or ethylen-vinyl acetate (EVA) said compounds being provided individually or in a mixture with one another, or with polyisobutylene.

16. The multi-layer barrier film according to claim 15, wherein the mixture of the polyolefin layer comprises linear low-density polyethylene (LLDPE)-metallocene.

17. The multi-layer barrier film according to claim 15, wherein the mixture of the polyolefin layer comprises LLDPE-butene, LLDPE-hexene, LLDPE-octene, LLDPE-metallocene, or VLLDPE individually or in a mixture with one another.

18. The multi-layer barrier film according to claim 1, wherein said film is composed of one or more barrier layers interposed between polyolefin layers.

19. The multi-layer barrier film according to claim 18, wherein at least one adhesive or binding layer is provided between the layers.

20. The multi-layer barrier film according to claim 19, wherein said adhesive or binding layer is composed of a mixture comprising or consisting of linear low-density polyethylene (LLDPE), low-density polyethylene (LDPE), ethylene vinyl acetate (EVA), or polypropylene, used pure or in a mixture with one another.

21. The multi-layer barrier film according to claim 19, wherein said adhesive or binding layer is a linear polyethylene-based layer.

22. The multi-layer barrier film according to claim 19, wherein said at least one adhesive or binding layer is provided between a barrier layer and a polyolefin layer.

23. The multi-layer barrier film according to claim 19, wherein a mixture composing said at least one adhesive layer or a mixture composing said at least one polyolefin layer contains additives provided in an amount ranging from 1 to 40% of a total weight of the mixture.

24. The multi-layer barrier film according to claim 1, wherein said film comprises one or more of the following layers:
a first polyolefin layer (A) composed of a mixture comprising linear low-density polyethylene (LLDPE) or low-density polyethylene (LDPE);
a second polyolefin layer (B) composed of a mixture comprising linear low-density polyethylene (LLDPE), low-density polyethylene (LDPE), or polypropylene;
a first layer (C) with an adhesive function;
said barrier layer (D) composed of a mixture consisting of or comprising at least one type of polyamide, ethylene vinyl alcohol (EVOH), polyvinyl alcohol (PVOH), polyvinyldene chloride (PVAL), or copolymers thereof provided individually or in a mixture with one another;
a second layer (C^{I}) with an adhesive function;
a third polyolefin layer (B^{I}) composed of a mixture comprising linear low-density polyethylene (LLDPE), low-density polyethylene (LDPE), or polypropylene; and
a fourth polyolefin layer (A^{I}) composed of a mixture comprising linear low-density polyethylene (LLDPE) or low-density polyethylene (LDPE).

25. The multi-layer barrier film according to claim 24, wherein:
one or both of said first or said fourth polyolefin layer (A) is composed of a mixture comprising linear low-density polyethylene (LLDPE)-butene, very low-density linear polyethylene (VLLDPE), or LLDPE-metallocene; and
one or both of said second or said third polyolefin layer (B) is composed of a mixture comprising LLDPE-metallocene.

26. The multi-layer barrier film according to claim 24, wherein a mixture composing at least one polyolefin layer comprises polyisobutylene or EVA.

27. The multi-layer barrier film according to claim 24, wherein a mixture composing one or more of at least one polyolefin layer or layers or at least one adhesive layer comprises coloring agents or anti-UV additives.

28. The multi-layer barrier film according to claim 24, wherein:
the polyolefin layer (A) is composed of a mixture of LLDPE or LDPE, to which one or more of the following compounds is added:
from 0 to 50% by weight of polyisobutylene or EVA;
from 0 to 20% by weight of a coloring agent;
from 0 to 20% by weight of anti-UV additives;
the polyolefin layer (B) is composed of a mixture of LLDPE, LDPE, or polypropylene, to which one or more of the following compounds is added:
from 0 to 50% by weight of polyisobutylene and/or EVA;
from 0 to 20% by weight of a coloring agent;
from 0 to 20% by weight of anti-UV additives;
the layer (C) with the adhesive function is composed of a mixture of linear low-density polyethylene, polypropylene, low-density polyethylene, or EVA to which there is added:
from 0% to 40% by weight of anti-UV additives;
the barrier layer (D) is composed of a mixture consisting of or comprising at least one polymer or copolymer selected from the group consisting of polyamide, ethylene vinyl alcohol (EVOH), polyvinyl alcohol (PVOH), or polyvinyldene chloride (PVAL), said polymer or copolymer being provided individually or in a mixture with one another;
the layer (C^{I}) with the adhesive function is composed of a mixture of linear low density polyethylene, polypropylene, low density polyethylene, or EVA, to which there is added:
from 0% to 40% by weight of anti-UV additives;
the polyolefin layer (B^{I}) is composed of a mixture of LLDPE, LDPE, or polypropylene, to which one or more of the following compounds is added:
from 0 to 50% by weight of polyisobutylene and/or EVA;
from 0 to 20% by weight of a coloring agent;
from 0 to 20% by weight of anti-UV additives;
a polyolefin layer (A^{I}) is composed of a mixture of LLDPE or LDPE, to which one or more of the following compounds is added:
from 0% to 40% by weight of polyisobutylene and/or EVA;
from 0 to 20% by weight of a coloring agent;
from 0 to 20% by weight of anti-UV additives.

29. The multi-layer barrier film according to claim 24, wherein:
the polyolefin layer (A) is composed of:
from 20 to 90% by weight of LLDPE-butene or VLLDPE;
from 10 to 80% by weight of LDPE-metallocene;
to which one or more of the following compounds is added:
from 5 to 50% by weight of polyisobutylene or EVA;
from 0 to 20% by weight of a coloring agent;
from 0 to 20% by weight of anti-UV additives;
the polyolefin layer (B) is composed of:
from 40 to 90% by weight of a LLDPE, to which one or more of the following compounds is added:
from 5 to 50% by weight of polyisobutylene or EVA;
from 0 to 20% by weight of a coloring agent;
from 0 to 20% by weight of anti-UV additives;
the layer (C) with the adhesive function is composed of:
from 60 to 100% by weight of linear polyethylene;
from 0% to 40% by weight of anti-UV additives;
the barrier layer (D) is composed of EVOH;
the layer (C^{I}) with the adhesive function is composed of:
from 60 to 100% by weight of linear polyethylene;
from 0% to 40% by weight of anti-UV additives;
the polyolefin layer (B^{I}) is composed of:
from 40 to 90% by weight of LLDPE, to which one or more of the following compounds is added:
from 5 to 50% by weight of polyisobutylene;
from 0 to 20% by weight of a coloring agent;
from 0 to 20% by weight of anti-UV additives;
the polyolefin layer (A^{I}) is composed of:
from 60 to 99% by weight of LLDPE, to which one or more of the following compounds is added:
from 0% to 40% by weight of polyisobutylene and/or EVA;
from 0 to 20% by weight of a coloring agent;
from 0 to 20% by weight of anti-UV additives.

30. A method of use of a multi-layer barrier film comprising the steps of:
providing a multi-layer barrier film made of a plastic material adapted for covering or wrapping natural products, said products being used both for animal feeding and as raw materials for plants producing energy from renewable sources comprising:
at least one barrier layer made of an air-impermeable plastic material for preventing aerobic fermentation of an ensiled product or for limiting fermentation to lactic fermentation caused by anaerobic microorganisms,
wherein said film has an oxygen permeability value, measured at 0% humidity and at 20° C., no higher than 300 cc/m²/day/atm when said film in a stretched or unstretched condition and an overall thickness no higher than 500 μm; and
disposing said multi-layer barrier film on an ensiled natural product for covering or wrapping said ensiled natural product.

31. The method of use according to claim 30, wherein said multi-layer barrier film has a thickness no higher than 50 μm,
further comprising the step of wrapping single round bales of a chopped vegetable material with said multi-layer barrier film.

32. The method of use according to claim 30, wherein said multi-layer barrier film has a thickness no lower than 25 μm and no higher than 250 μm,
further comprising the step of covering an ensiled vegetable product with said multi-layer barrier film.

33. The method of use according to claim 30, wherein said multi-layer barrier film has a thickness no lower than 130 μm and no higher than 500 μm,
further comprising the step of storing and preserving a chopped vegetable product inside tubes made from said multi-layer barrier film.
